(19) United States
(12) Patent Application Publication
(10) Pub. No.: US 2021/0303790 A1
(43) Pub. Date: Sep. 30, 2021

(54) INFORMATION PROCESSING APPARATUS

(71) Applicant: FUJIFILM Business Innovation Corp., Tokyo (JP)

(72) Inventors: Shusaku Kubo, Kanagawa (JP); Kunihiko Kobayashi, Kanagawa (JP); Shigeru Okada, Kanagawa (JP); Yusuke Suzuki, Kanagawa (JP); Shintaro Adachi, Kanagawa (JP)

(73) Assignee: FUJIFILM Business Innovation Corp., Tokyo (JP)

(21) Appl. No.: 16/931,353

(22) Filed: Jul. 16, 2020

(30) Foreign Application Priority Data
Mar. 27, 2020 (JP) 2020-058736

(51) Int. Cl. G06F 40/289; G06F 40/205

(52) U.S. Cl. CPC G06F 40/289; G06F 40/205

(57) ABSTRACT

An information processing apparatus includes a processor configured to acquire an image showing a document, recognize characters from the acquired image, generate a connected character string by connecting sequences of the recognized characters at line breaks in a text, and extract a portion corresponding to specified information from the generated connected character string.

### CROSS-REFERENCE TO RELATED APPLICATIONS

This application is based on and claims priority under 35 USC 119 from Japanese Patent Application No. 2020-058736 filed Mar. 27, 2020.

### BACKGROUND

### (i) Technical Field

The present disclosure relates to an information processing apparatus.

### (ii) Related Art

Japanese Unexamined Patent Application Publication No. 2004-178044 describes a technology for extracting an attribute of a document by extracting a character field that appears within a predetermined range in the document and searching for a match with a word class pattern.

### SUMMARY

Aspects of non-limiting embodiments of the present disclosure relate to the following circumstances. In the technology of Japanese Unexamined Patent Application Publication No. 2004-178044, information may be extracted from a document such as a business card, in which characters appears within predetermined ranges. However, information that appears as a part of a text, such as names of parties in a contract document, is difficult to extract because the information appears at a random point in the document. The information is more difficult to extract if the information appears across a line break in the text.

It is desirable to appropriately extract information that appears as a part of a text.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to acquire an image showing a document, recognize characters from the acquired image, generate a connected character string by connecting sequences of the recognized characters at line breaks in a text, and extract a portion corresponding to specified information from the generated connected character string.

### BRIEF DESCRIPTION OF THE DRAWINGS

An exemplary embodiment of the present disclosure will be described in detail based on the following figures, wherein:

FIG. 1 illustrates the overall configuration of an information extraction assistance system according to an exemplary embodiment;

FIG. 2 illustrates the hardware configuration of a document processing apparatus;

FIG. 3 illustrates the hardware configuration of a reading apparatus;

FIG. 4 illustrates a functional configuration implemented by the information extraction assistance system;

FIG. 5 illustrates an example of line breaks in a text;

FIG. 6 illustrates an example of a generated connected character string;

FIG. 7 illustrates an example of a character string table;

FIGS. 8A to 8C illustrate an example of extraction of specified information;

FIGS. 9A and 9B illustrate an example of a screen related to the extraction of the specified information; and

FIG. 10 illustrates an example of an operation procedure in an extraction process.

### DETAILED DESCRIPTION

### [1] Exemplary Embodiment

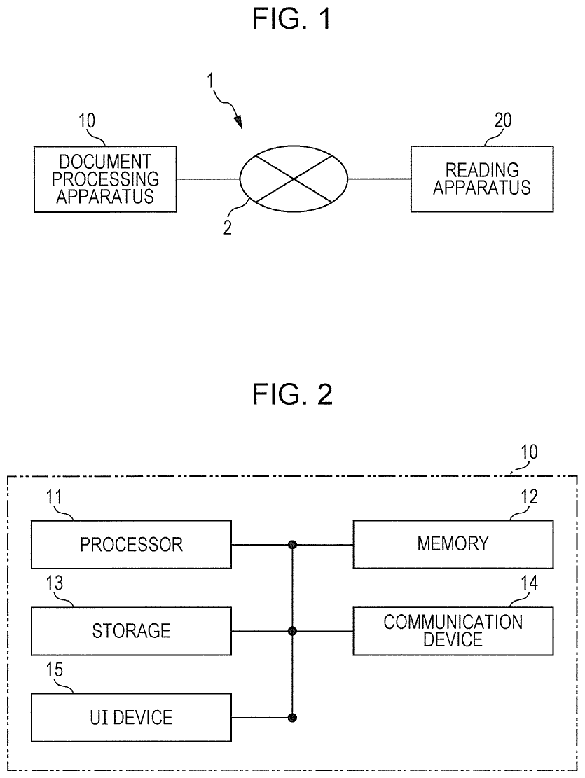

FIG. 1 illustrates the overall configuration of an information extraction assistance system 1 according to an exemplary embodiment. The information extraction assistance system 1 extracts specified information from a document. The document is a medium in which contents are described by using characters. The medium includes not only tangibles such as books but also intangibles such as electronic books.

Examples of the characters in the document include alphabets, Chinese characters (kanji), Japanese characters (hiragana and katakana), and symbols (e.g., punctuation marks). A text is composed of a plurality of sentences. A sentence is a character string having a period (“.”) at the end. In this exemplary embodiment, information such as a name of a party, a product name, or a service name is extracted from a contract document that is an example of the document.

The information extraction assistance system 1 includes a communication line 2, a document processing apparatus 10, and a reading apparatus 20. The communication line 2 is a communication system including a mobile communication network and the Internet and relays data exchange between apparatuses that access the system. The document processing apparatus 10 and the reading apparatus 20 access the communication line 2 by wire. The apparatuses may access the communication line 2 by wireless.

The reading apparatus 20 is an information processing apparatus that reads a document and generates image data showing characters or the like in the document. The reading apparatus 20 generates contract document image data by reading an original contract document. The document processing apparatus 10 is an information processing apparatus that extracts information based on a contract document image. The document processing apparatus 10 extracts information based on the contract document image data generated by the reading apparatus 20.

FIG. 2 illustrates the hardware configuration of the document processing apparatus 10. The document processing apparatus 10 is a computer including a processor 11, a memory 12, a storage 13, a communication device 14, and a user interface (UI) device 15. The processor 11 includes an arithmetic unit such as a central processing unit (CPU), a register, and a peripheral circuit. The memory 12 is a recording medium readable by the processor 11 and includes a random access memory (RAM) and a read only memory (ROM).

The storage 13 is a recording medium readable by the processor 11. Examples of the storage 13 include a hard disk drive and a flash memory. The processor 11 controls operations of hardware by executing programs stored in the ROM or the storage 13 with the RAM used as a working area. The communication device 14 includes an antenna and a communication circuit and is used for communications via the communication line 2.

The UI device 15 is an interface for a user of the document processing apparatus 10. For example, the UI device 15 includes a touch screen with a display and a touch panel on the surface of the display. The UI device 15 displays images and receives user's operations. The UI device 15 includes an operation device such as a keyboard in addition to the touch screen and receives operations on the operation device.

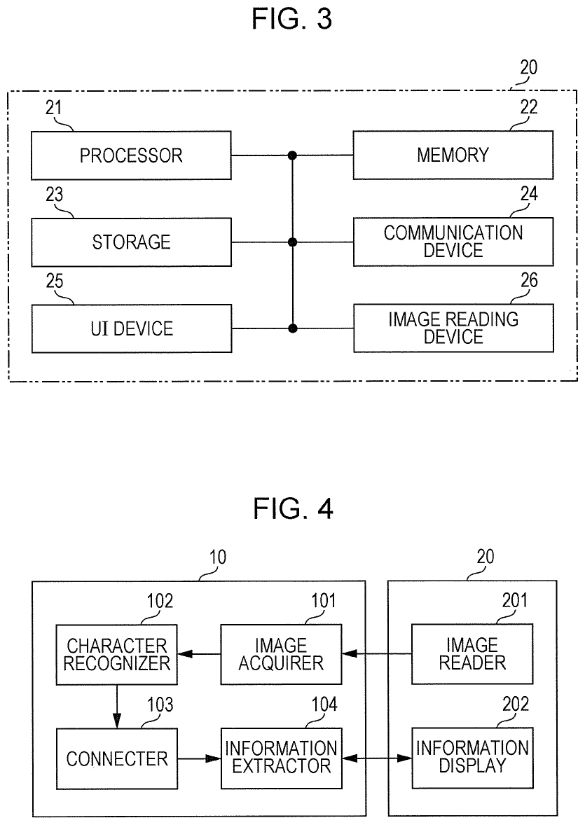

FIG. 3 illustrates the hardware configuration of the reading apparatus 20. The reading apparatus 20 is a computer including a processor 21, a memory 22, a storage 23, a communication device 24, a UI device 25, and an image reading device 26. The processor 21 to the UI device 25 are the same types of hardware as the processor 11 to the UI device 15 of FIG. 2.

The image reading device 26 reads a document and generates image data showing characters or the like (characters, symbols, pictures, or graphical objects) in the document. The image reading device 26 is a so-called scanner. The image reading device 26 has a color scan function to read colors of characters or the like in the document.

In the information extraction assistance system 1, the processors of the apparatuses described above control the respective parts by executing the programs, thereby implementing the following functions. Operations of the functions are also described as operations to be performed by the processors of the apparatuses that implement the functions.

FIG. 4 illustrates a functional configuration implemented by the information extraction assistance system 1. The document processing apparatus 10 includes an image acquirer 101, a character recognizer 102, a connecter 103, and an information extractor 104. The reading apparatus 20 includes an image reader 201 and an information display 202.

The image reader 201 of the reading apparatus 20 controls the image reading device 26 to read characters or the like in a document and generate an image showing the document (hereinafter referred to as “document image”). When a user sets each page of an original contract document on the image reading device 26 and starts a reading operation, the image reader 201 generates a document image in every reading operation.

The image reader 201 transmits image data showing the generated document image to the document processing apparatus 10. The image acquirer 101 of the document processing apparatus 10 acquires the document image in the transmitted image data as an image showing a closed-contract document. The image acquirer 101 supplies the acquired document image to the character recognizer 102. The character recognizer 102 recognizes characters from the supplied document image.

For example, the character recognizer 102 recognizes characters by using a known optical character recognition (OCR) technology. First, the character recognizer 102 analyzes the layout of the document image to identify regions including characters. For example, the character recognizer 102 identifies each line of characters. The character recognizer 102 extracts each character in a rectangular image by recognizing a blank space between the characters in each line.

The character recognizer 102 calculates the position of the extracted character (to be recognized later) in the image. For example, the character recognizer 102 calculates the character position based on coordinates in a two-dimensional coordinate system having its origin at an upper left corner of the document image. For example, the character position is the position of a central pixel in the extracted rectangular image. The character recognizer 102 recognizes the character in the extracted rectangular image by, for example, normalization, feature amount extraction, matching, and knowledge processing.

In the normalization, the size and shape of the character are converted into predetermined size and shape. In the feature amount extraction, an amount of a feature of the character is extracted. In the matching, feature amounts of standard characters are prestored and a character having a feature amount closest to the extracted feature amount is identified. In the knowledge processing, word information is prestored and a word including the recognized character is corrected into a similar prestored word if the word has no match.

The character recognizer 102 supplies the connecter 103 with character data showing the recognized characters, the calculated positions of the characters, and a direction of the characters (e.g., a lateral direction if the characters are arranged in a row). The connecter 103 generates a character string by connecting character sequences at line breaks in a text composed of the characters recognized by the character recognizer 102 (the generated character string is hereinafter referred to as “connected character string”).

The term “line break” herein means that a sentence breaks at some point in the middle to enter a new line. The line break includes not only an explicit line break made by an author but also a word wrap (also referred to as “in-paragraph line break”) automatically made by a document creating application.

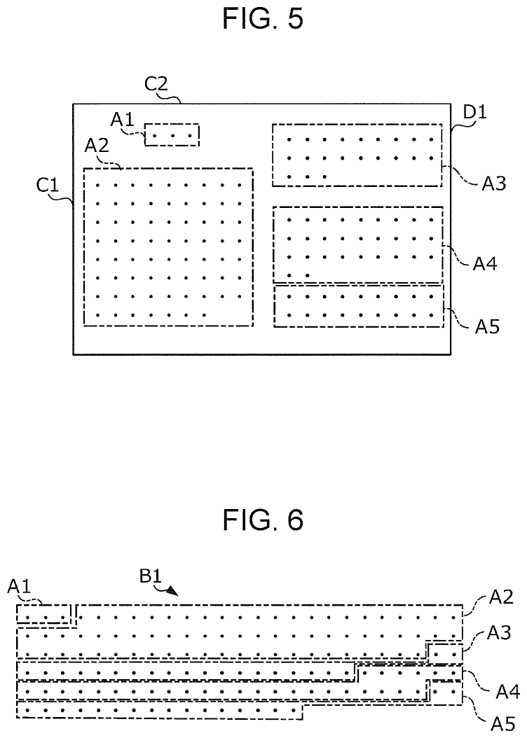

FIG. 5 illustrates an example of line breaks in a text. FIG. 5 illustrates a document image Dl showing a title A1 and paragraphs A2, A3, A4, and A5. In each of the title A1 to the paragraph A5, characters are arranged from the beginning to the end until an explicit line break is made. The connecter 103 identifies character sequences in the text based on the positions of the characters and the direction of the characters in the character data supplied from the character recognizer 102.

In this exemplary embodiment, the connecter 103 identifies character sequences in the title A1 to the paragraph A5 in the document image Dl. In this case, the connecter 103 connects a character string in a line preceding an in-paragraph line break and a character string in a line succeeding the in-paragraph line break. Next, the connecter 103 determines the order of the identified character sequences. In the document image Dl, the connecter 103 determines the order of the character sequences based on a distance from a left side C1 and a distance from an upper side C2.

Specifically, the connecter 103 determines the order so that a character sequence whose distance from the left side C1 is smaller than a half of the length of the upper side C2 precedes a character sequence whose distance from the left side C1 is equal to or larger than the half of the length of the upper side C2. The connecter 103 determines the order so that a character sequence whose distance from the left side C1 is smaller than the half of the length of the upper side C2 precedes other character sequences as the distance from the upper side C2 decreases and a character sequence whose distance from the left side C1 is equal to or larger than the half of the length of the upper side C2 precedes other character sequences as the distance from the upper side C2 decreases.

In the example of FIG. 5, the connecter 103 determines the order so that the title A1 comes first, the paragraphs A2, A3, and A4 follow the title A1, and the paragraph A5 comes last. The connecter 103 generates a connected character string by connecting the identified character sequences in the determined order. The generated connected character string is obtained by connecting the character sequences at the line breaks in the text. In this example, the connecter 103 identifies character sequences connected in advance at in-paragraph line breaks but may identify character sequences in individual lines without connecting the character sequences in advance at the in-paragraph line breaks. Also in this case, the connecter 103 generates a connected character string by determining the order of the character sequences in the individual lines by the same method.

FIG. 6 illustrates an example of the generated connected character string. In the example of FIG. 6, the connecter 103 generates a connected character string B1 by connecting the title A1, the paragraph A2, the paragraph A3, the paragraph A4, and the paragraph A5 in this order. The connected character string B1 is obtained by connecting the character sequences at the line breaks in the text in the document image Dl. The connecter 103 supplies the information extractor 104 with character string data showing the generated connected character string.

The information extractor 104 extracts a portion corresponding to specified information (hereinafter referred to simply as “specified information”) from the generated connected character string. In this exemplary embodiment, if the connected character string includes at least one of a plurality of first character strings, the information extractor 104 extracts, as the specified information, a second character string positioned under a rule associated with the included first character string.

The information extractor 104 excludes a predetermined word from the extracted specified information and extracts information remaining after the exclusion as the specified information. The information extractor 104 extracts the specified information by using a character string table in which the first character strings, the second character strings, and excluded words (predetermined words to be excluded) are associated with each other.

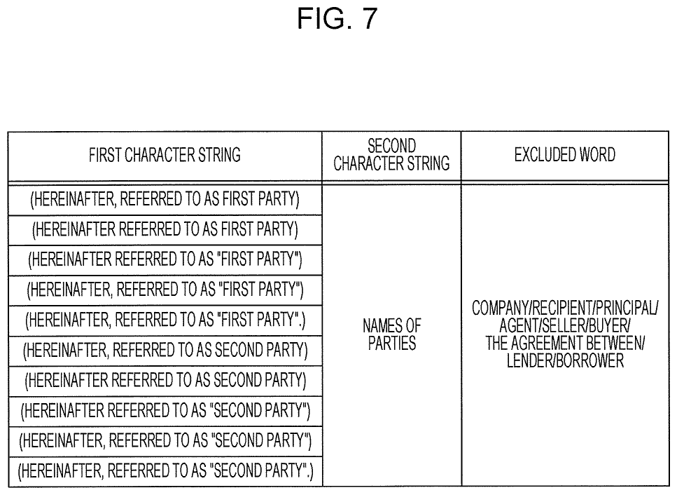

FIG. 7 illustrates an example of the character string table. In the example of FIG. 7, first character strings “(hereinafter, referred to as first party)”, “(hereinafter referred to as first party)”, “(hereinafter referred to as “first party”)”, “(hereinafter, referred to as “first party”)”, “(hereinafter, referred to as “first party”.)”, “(hereinafter, referred to as second party)”, “(hereinafter referred to as second party)”, “(hereinafter referred to as “second party”)”, “(hereinafter, referred to as “second party”)”, and “(hereinafter, referred to as “second party”.)” are associated with second character strings “names of parties”.

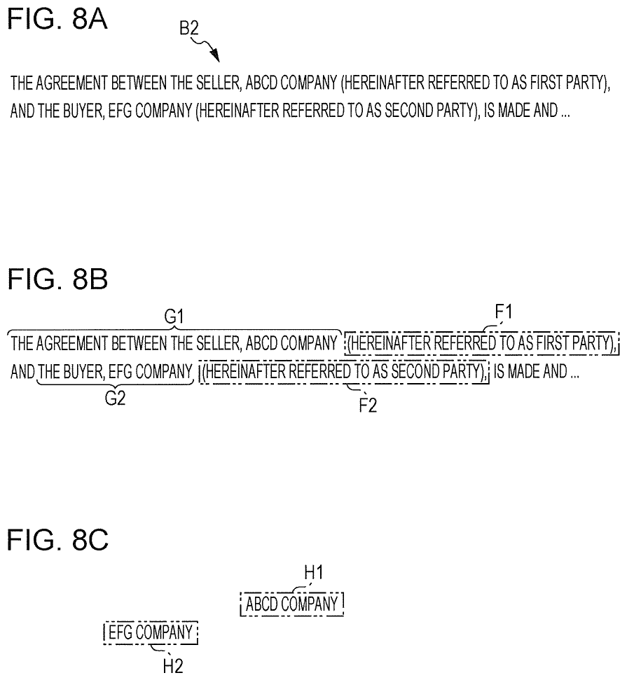

The second character strings “names of parties” are associated with excluded words “company”, “recipient”, “principal”, “agent”, “seller”, “buyer”, “the agreement between”, “lender”, and “borrower”. An example of the extraction of specified information using the character string table is described with reference to FIGS. 8A to 8C.

FIGS. 8A to 8C illustrate the example of the extraction of specified information. FIG. 8A illustrates a connected character string B2 “The agreement between the seller, ABCD Company (hereinafter referred to as first party), and the buyer, EFG Company (hereinafter referred to as second party), is made and . . . .”

The information extractor 104 retrieves character strings that match the first character strings from the connected character string in the supplied character string data. In the example of FIGS. 8A to 8C, the information extractor 104 retrieves a character string F1 “(hereinafter referred to as first party)” and a character string F2 “(hereinafter referred to as second party)” as illustrated in FIG. 8B. The information extractor 104 acquires character strings preceding the respective retrieved character strings.

If any retrieved character string precedes another retrieved character string, the information extractor 104 acquires characters immediately succeeding the preceding character string. If a comma (“,”) precedes a retrieved character string, the information extractor 104 acquires characters immediately succeeding the comma. In the example of FIGS. 8A to 8C, the information extractor 104 acquires a character string G1 “The agreement between the seller, ABCD Company” preceding the character string F1 as illustrated in FIG. 8B.

Not only the character string F1 but also a comma precedes the character string F2. Therefore, the information extractor 104 acquires a character string G2 “the buyer, EFG Company” in a range from a character immediately succeeding the comma to a character immediately preceding the character string F2. Then, the information extractor 104 excludes excluded words from the acquired character strings G1 and G2. For example, the information extractor 104 excludes the excluded words “the agreement between” and “seller” from the character string G1 and extracts a character string H1 “ABCD Company” as illustrated in FIG. 8C.

The information extractor 104 excludes the excluded word “buyer” from the character string G2 and extracts a character string H2 “EFG Company” as illustrated in FIG. 8C. In this exemplary embodiment, the excluded words include words that mean specific designations of persons or entities in a document. In this exemplary embodiment, the “person or entity” is a party to a contract and the “word that means specific designation” is “company”, “recipient”, “principal”, “agent”, “seller”, “buyer”, “lender”, or “borrower”. The designation such as “company” is a special name assigned to the party to the contract.

The information extractor 104 transmits specified information data showing the extracted specified information to the reading apparatus 20. The information display 202 of the reading apparatus 20 displays the extracted specified information. For example, the information display 202 displays a screen related to the extraction of the specified information.

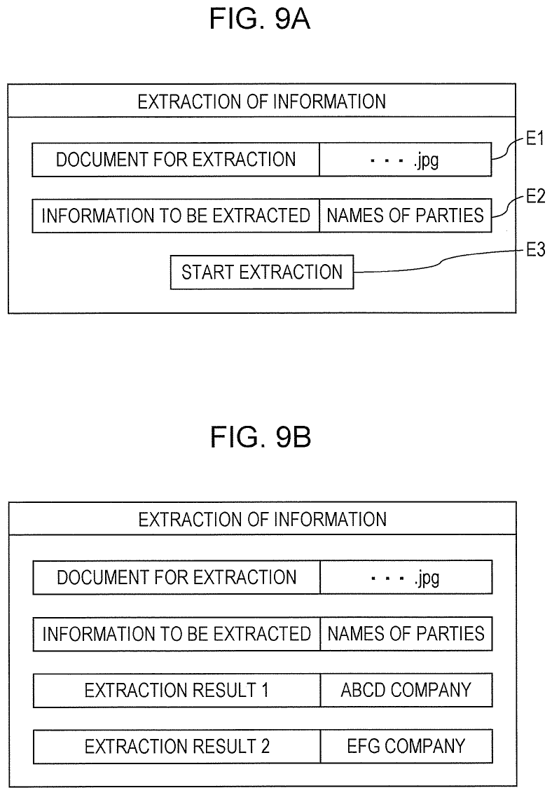

FIGS. 9A and 9B illustrate an example of the screen related to the extraction of the specified information. In the example of FIG. 9A, the information display 202 displays an information extraction screen including a document specifying field E1, an information specifying field E2, and an extraction start button E3. In the document specifying field E1, a user specifies a document from which the user wants to extract specified information. In the information specifying field E2, the user specifies information to be extracted. In response to the user pressing the start button E3, the information display 202 transmits, to the document processing apparatus 10, extraction request data showing the document specified in the document specifying field E1 and the information specified in the information specifying field E2.

In response to reception of the extraction request data, the information extractor 104 of the document processing apparatus 10 extracts the specified information shown in the extraction request data from a connected character string in the document shown in the extraction request data. The information extractor 104 transmits specified information data showing the extracted specified information to the reading apparatus 20. As illustrated in FIG. 9B, the information display 202 receives the specified information data and displays the specified information as an extraction result.

With the configurations described above, the apparatuses in the information extraction assistance system 1 perform an extraction process for extracting the specified information.

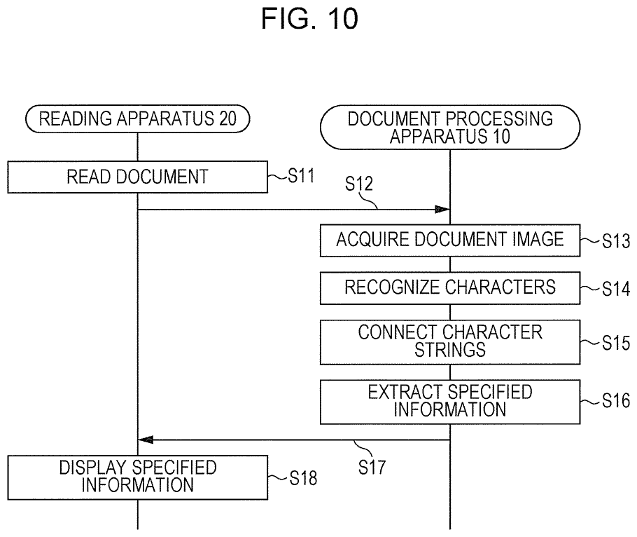

FIG. 10 illustrates an example of an operation procedure in the extraction process. First, the reading apparatus 20 (image reader 201) reads characters or the like in a set contract document and generates a document image (Step S11). Next, the reading apparatus 20 (image reader 201) transmits image data showing the generated document image to the document processing apparatus 10 (Step S12).

The document processing apparatus 10 (image acquirer 101) acquires the document image in the transmitted image data (Step S13). Next, the document processing apparatus 10 (character recognizes 102) recognizes characters from the acquired document image (Step S14). Next, the document processing apparatus 10 (connecter 103) generates a connected character string by connecting sequences of the recognized characters at line breaks in a text (Step S15).

Next, the document processing apparatus 10 (information extractor 104) extracts a portion corresponding to specified information from the generated connected character string (Step S16). Next, the document processing apparatus 10 (information extractor 104) transmits specified information data showing the extracted specified information to the reading apparatus 20 (Step S17). The reading apparatus 20 (information display 202) displays the specified information in the transmitted specified information data (Step S18).

A character string in a document breaks into two character strings at an in-paragraph line break. For example, “ABCD Company” in FIG. 8 may break into “ABCD” and “Company” at an in-paragraph line break. In this case, the name of the party “ABCD Company” is not extracted as the specified information. In this exemplary embodiment, the connected character string is generated and the specified information is extracted.

### [2] Modified Examples

### [2-1] Information Extraction Method

The information extractor 104 may extract specified information by a method different from the method of the exemplary embodiment. For example, the information extractor 104 may extract a word in a specific word class as the specified information from a connected character string generated by the connecter 103. Examples of the specific word class include a proper noun. If specified information is extracted from a contract document, the document includes, for example, “company name”, “product name”, or “service name” as a proper noun.

For example, the information extractor 104 prestores a list of proper nouns that may appear in a document and searches a connected character string for a match with the listed proper nouns. If the information extractor 104 finds a match with the listed proper nouns as a result of the search, the information extractor 104 extracts the proper noun as specified information.

### [2-2] Split of Text

In the exemplary embodiment, one connected character string is generated in one document but a plurality of connected character strings may be generated in one document. In this modified example, the connecter 103 generates a plurality of connected character strings by splitting a text in a document. For example, the connecter 103 splits the text across a specific character in the text.

The information extractor 104 sequentially extracts pieces of specified information from the plurality of connected character strings and terminates the extraction of the specified information if a predetermined termination condition is satisfied. Examples of the specific character include a colon (“:”), a phrase “Chapter X” (“X” represents a number), and a “character followed by blank space”. Those characters serve as breaks in the text. Sentences preceding and succeeding the specific character are punctuated and therefore the character string hardly breaks across the specific character.

Examples of the termination condition include a condition to be satisfied when the information extractor 104 extracts at least one piece of necessary specified information.

For example, the information extractor 104 may extract a “name of party” and a “product name” from a contract document. In this case, the information extractor 104 determines that the termination condition is satisfied when at least one “name of party” and at least one “product name” are extracted from separate connected character strings. Thus, the information extractor 104 terminates the extraction of the specified information. In this case, no specified information may be extracted from any of the separate connected character strings.

The method for splitting a connected character string is not limited to the method described above. For example, the connecter 103 may split a text at a point that depends on the type of specified information. For example, if the type of the specified information is “name of party”, the connecter 103 generates connected character strings by splitting a beginning part of a document (e.g., first 10% of the document) from the succeeding part. The name of a party may appear in the beginning part of the document with a stronger possibility than in the other part.

If the type of the specified information is “signature of party to contract”, the connecter 103 generates connected character strings by splitting an end part of the document (e.g., last 10% of the document) from the preceding part. In this case, the information extractor 104 may sequentially extract pieces of specified information in order from a connected character string at a part that depends on the type of the specified information (end part of a text in the example of “signature of party to contract”) among the plurality of separate connected character strings.

The connecter 103 may split a text at a point that depends on the type of a document from which specified information is extracted. For example, if the type of the document is “contract document”, the connecter 103 splits a connected character string at a ratio of 1:8:1 from the beginning of the document. If the type of the document is “proposal document”, the connecter 103 splits a connected character string at a ratio of 1:4:4:1 from the beginning of the document.

In this case, the information extractor 104 sequentially extracts pieces of specified information in order from a connected character string at a part that depends on the type of the document among the plurality of separate connected character strings. For example, if the type of the document is “contract document”, the information extractor 104 extracts pieces of specified information in order of the top connected character string, the last connected character string, and the middle connected character string that are obtained by splitting at the ratio of 1:8:1.

If the type of the document is “proposal document”, the information extractor 104 extracts pieces of specified information in order of the first connected character string, the fourth connected character string, the second connected character string, and the third connected character string that are obtained by splitting at the ratio of 1:4:4:1. In the contract document, the “name of party”, the “product name”, and the “service name” to be extracted as the specified information tend to appear at the beginning of the document. Further, the “signature of party to contract” to be extracted as the specified information tends to appear at the end of the document.

In the proposal document, a “customer name”, a “proposing company name”, a “product name”, and a “service name” to be extracted as the specified information tend to appear at the beginning or end of the document.

### [2-3] Split of Image

For example, if a document image is generated by reading a two-page spread, two pages may be included in one image. If a document image is generated in four-up, eight-up, or other page layouts, three or more pages may be included in one image. If the document image acquired by the image acquirer 101 has a size corresponding to a plurality of pages of the document, the character recognizer 102 recognizes characters after the document image is split into as many images as the pages.

The document image is generally rectangular. For example, the character recognizer 102 detects a region without recognized characters and with a maximum width (hereinafter referred to as “non-character region”) in a rectangular region without the corners of the acquired document image between two sides facing each other. If the width is equal to or larger than a threshold, the character recognizer 102 determines that the number of regions demarcated by the non-character region is the number of pages in one image.

The term “width” herein refers to a dimension in a direction orthogonal to a direction from one side to the other. After the determination, for example, the character recognizer 102 generates new separate document images by splitting the document image along a line passing through the center of the non-character region in the width direction. The character recognizer 102 recognizes characters in each of the generated separate images similarly to the exemplary embodiment.

If two or more pages are included in one image, erroneous determination may be made, for example, that a line on the left page is continuous with a line on the right page instead of a lower line on the left page depending on the sizes of the characters and the distances between the characters. In this modified example, the image is split into as many images as the pages as a countermeasure.

### [2-4] Erasing of Unnecessary Portion

The character recognizer 102 may recognize characters after a portion that satisfies a predetermined condition (hereinafter referred to as “erasing condition”) is erased from the document image acquired by the image acquirer 101. The portion that satisfies the erasing condition is unnecessary for character recognition and is hereinafter referred to also as “unnecessary portion”.

Specifically, the character recognizer 102 erases a portion having a specific color from the acquired document image as the portion that satisfies the condition. Examples of the specific color include red of a seal and navy blue of a signature.

The character recognizer 102 may erase, from the acquired document image, a portion other than a region including recognized characters as the unnecessary portion. For example, the character recognizer 102 identifies a smallest quadrangle enclosing the recognized characters as the character region. The character recognizer 102 erases a portion other than the identified character region as the unnecessary portion. After the unnecessary portion is erased, the character recognizer 102 recognizes the characters in a contract similarly to the exemplary embodiment.

For example, the document image obtained by reading the contract document may include a shaded region due to a fold line or a binding tape between pages. If the shaded region is read and erroneously recognized as characters, the accuracy of extraction of specified information may decrease. In this modified example, the erasing process described above is performed as a countermeasure.

### [2-5] Conversion of Unnecessary Portion

The character recognizer 102 erases an unnecessary portion in a document image but may convert the document image into an image with no unnecessary portion. As a result, the unnecessary portion is erased. To convert the image, for example, machine learning called generative adversarial networks (GAN) may be used.

The GAN is an architecture in which two networks (generator and discriminator) learn competitively. The GAN is often used as an image generating method. The generator generates a false image from a random noise image. The discriminator determines whether the generated image is a “true” image included in teaching data.

For example, the character recognizer 102 generates a contract document image with no signature by the GAN and recognizes characters based on the generated image similarly to the exemplary embodiment. Thus, the character recognizer 102 of this modified example recognizes the characters based on the image obtained by converting the acquired document image.

### [2-6] Document Image

In the exemplary embodiment, the image acquirer 101 acquires a document image generated by reading an original contract document but may acquire, for example, a document image shown in contract document data electronically created by an electronic contract exchange system. Similarly, the image acquirer 101 may acquire a document image shown in electronically created document data irrespective of the type of the document.

### [2-7] Functional Configuration

In the information extraction assistance system 1, the method for implementing the functions illustrated in FIG. 4 is not limited to the method described in the exemplary embodiment. For example, the document processing apparatus 10 may have all the elements in one housing or may have the elements distributed in two or more housings like computer resources provided in a cloud service.

At least one of the image acquirer 101, the character recognizer 102, the connecter 103, or the information extractor 104 may be implemented by the reading apparatus 20. At least one of the image reader 201 or the information display 202 may be implemented by the document processing apparatus 10.

In the exemplary embodiment, the information extractor 104 performs both the process of extracting specified information and the process of excluding the excluded words. Those processes may be performed by different functions. Further, the operations of the connecter 103 and the information extractor 104 may be performed by one function. In short, the configurations of the apparatuses that implement the functions and the operation ranges of the functions may freely be determined as long as the functions illustrated in FIG. 4 are implemented in the information extraction assistance system as a whole.

### [2-8] Processor

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

### [2-9] Category

The exemplary embodiment of the present disclosure may be regarded not only as information processing apparatuses such as the document processing apparatus 10 and the reading apparatus 20 but also as an information processing system including the information processing apparatuses (e.g., information extraction assistance system 1). The exemplary embodiment of the present disclosure may also be regarded as an information processing method for implementing processes to be performed by the information processing apparatuses, or as programs causing computers of the information processing apparatuses to implement functions. The programs may be provided by being stored in recording media such as optical discs, or may be installed in the computers by being downloaded via communication lines such as the Internet.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
acquire an image showing a document,
recognize characters from the acquired image,
generate a connected character string by connecting sequences of the recognized characters at line breaks in a text, and
extract a portion corresponding to specified information from the generated connected character string.

2. The information processing apparatus according to claim 1, wherein the processor recognizes the characters after a portion that satisfies a predetermined condition is erased from the acquired image.

3. The information processing apparatus according to claim 2, wherein the portion that satisfies the condition is a portion having a specific color.

4. The information processing apparatus according to claim 1, wherein the processor recognizes the characters based on an image obtained by converting the acquired image.

5. The information processing apparatus according to claim 1, wherein the processor is configured to
generate a plurality of connected character strings by splitting the text,
sequentially extract portions corresponding to the specified information from the plurality of connected character strings, and
terminate the extraction if a predetermined termination condition is satisfied.

6. The information processing apparatus according to claim 5, wherein the processor splits the text across a specific character in the text.

7. The information processing apparatus according to claim 5, wherein the processor splits the text at a point that depends on a type of the specified information.

8. The information processing apparatus according to claim 5, wherein the processor splits the text at a point that depends on a type of the document.

9. The information processing apparatus according to claim 1, wherein, if the acquired image has a size corresponding to a plurality of pages of the document, the processor recognizes the characters after the image is split into as many images as the pages.

10. The information processing apparatus according to claim 2, wherein, if the acquired image has a size corresponding to a plurality of pages of the document, the processor recognizes the characters after the image is split into as many images as the pages.

11. The information processing apparatus according to claim 3, wherein, if the acquired image has a size corresponding to a plurality of pages of the document, the processor recognizes the characters after the image is split into as many images as the pages.

12. The information processing apparatus according to claim 4, wherein, if the acquired image has a size corresponding to a plurality of pages of the document, the processor recognizes the characters after the image is split into as many images as the pages.

13. The information processing apparatus according to claim 5, wherein, if the acquired image has a size corresponding to a plurality of pages of the document, the processor recognizes the characters after the image is split into as many images as the pages.

14. The information processing apparatus according to claim 6, wherein, if the acquired image has a size corresponding to a plurality of pages of the document, the processor recognizes the characters after the image is split into as many images as the pages.

15. The information processing apparatus according to claim 7, wherein, if the acquired image has a size corresponding to a plurality of pages of the document, the processor recognizes the characters after the image is split into as many images as the pages.

16. The information processing apparatus according to claim 1, wherein, if the connected character string includes at least one of a plurality of first character strings, the processor extracts, as the portion, a second character string positioned under a rule associated with the included first character string.

17. The information processing apparatus according to claim 1, wherein the processor excludes a predetermined word from the extracted portion.

18. The information processing apparatus according to claim 17, wherein the predetermined word is a word that means a specific designation of a person or an entity in the document.

19. The information processing apparatus according to claim 1, wherein the processor extracts, as the portion, a word in a specific word class from the generated connected character string.

20. The information processing apparatus according to claim 19, wherein the word class is a proper noun.
